(19) United States
(12) Patent Application Publication
(10) Pub. No.: US 2026/0033488 A1
(43) Pub. Date: Feb. 5, 2026

(54) AUTOMATED VITRIFICATION CRYOPRESERVATION SYSTEM

(71) Applicant: FERTILITY PRESERVATION CANADA LTD., Ottawa (CA)

(72) Inventors: Qiuping PENG, North Hamilton (CA); Seang Lin TAN, Westmount (CA); Songguo XUE, Shanghai (CN)

(21) Appl. No.: 19/099,037

(22) PCT Filed: Jul. 27, 2023
(86) PCT No.: PCT/CA2023/051014

§ 371 Date: Jan. 27, 2025

(30) Foreign Application Priority Data
Jul. 27, 2022 (CN) 202221952830.0

(51) Int. Cl. A01N 1/162

(52) U.S. Cl. CPC A01N 1/162

(57) ABSTRACT

An automated processing system for vitrification-cryopreservation comprising a control mechanism for fixing and controlling the displacement of a cryo-carrier holding thereon samples to undergo vitrification-cryopreservation. The control mechanism achieves operations such as flipping, lifting, and translation of the cryo-carrier, thereby immersing or detaching the samples to be cryopreserved on the cryo-carrier from the cryoprotectant. The control mechanism can also transport the cryo-carrier to a cryogenic device and immerse the samples to be cryopreserved in the refrigerant for freezing.

### CROSS-REFERENCE TO RELATED APPLICATIONS

This application claims the benefits of China patent application No. 202221952830.0 filed on Jul. 27, 2022, which is herein incorporated by reference.

### TECHNICAL FIELD

The present disclosure relates to an automated vitrification cryopreservation system, more particularly for the cryopreservation of embryos.

### BACKGROUND

In the field of assisted reproduction, the long-term cryopreservation of gametes, zygotes, embryos at different stages, blastocysts, ovarian tissue, or testicular tissue of humans or animals, is a critical step in assisted reproductive technology.

Currently, the emerging method of cryopreservation is vitrification, which has replaced the traditional slow freezing method and has gained wide recognition in the medical community. The basic principle of vitrification cryopreservation involves freezing the biological sample in an ultra-low temperature environment using a high concentration cryoprotectant, forming an irregular glassy solid (vitrified state). The vitrified state maximally preserves the normal molecular and ionic distribution within cells, providing protection during the process of cellular vitrification and minimizing damage caused by ice crystal formation.

During the cryopreservation process, cells or tissues to be frozen need to be loaded onto specific cryopreservation carriers (cryo-carrier). Traditional cryo-carrier mainly includes pulled capillary straws, Cryoloop™, Cryotops™ and Cryoleaf™, etc.

Patent document CN209331001 U and US-20220007636-A1 disclose a cryo-carrier comprising multiple grids formed by nylon mesh, with a loading area for embryos and a non-embryo loading area surrounding the embryo loading area. The non-embryo loading area is filled with supporting strips to make it harder than the embryo loading area, thereby supporting the embryo loading area. With this structure, when embryos are placed in the embryo loading area, a portion of the embryos in direct contact with the grid can extend below the grid, allowing direct contact with liquid nitrogen during vitrification without forming a bubble insulation layer. Moreover, the grid facilitates heat transfer in all directions, thereby increasing the cooling rate during vitrification-freezing. Additionally, the higher hardness of the non-embryo loading area provides support to the embryo loading area, ensuring both the cooling rate and ease of operation during the process of cryopreservation. In summary, the before mentioned cryo-carrier provides a carrier suitable for vitrification-freezing, improving the effectiveness of vitrification-freezing.

In addition, before loading cells or tissues onto a cryo-carrier and subjecting them to vitrification-freezing in liquid nitrogen, it is necessary to perform the procedures of immersing the cells or tissues in cryoprotectants and removing excess cryoprotectants. In conventional experiments, vitrification-freezing of oocytes and embryos is typically performed manually. The general process involves equilibrating the samples with cryoprotectants of varying concentrations, loading the samples onto a cryo-carrier, and then immersing them in liquid nitrogen to achieve vitrification-freezing. This entire process is cumbersome, and more importantly, operators require extensive training to achieve favorable clinical outcomes. Moreover, there can be significant variations between different operators.

Accordingly, there is a clear need for an automated vitrification cryopreservation system achieving constant favorable clinical outcomes, thus eliminating variations due to varying levels of proficiency and training of manual operators.

### SUMMARY

There is provided an automated vitrification cryopreservation system, comprising:
a control mechanism including a fixing member for securing thereto a cryo-carrier having a securing portion and a supporting portion, and a drive system for controlling displacement the fixing member;
the drive system including an output shaft and:
a rotational drive unit for controlling rotational movement of the output shaft;
a lifting drive unit for controlling vertical movement of the output shaft; and
a translational drive unit for controlling horizontal movement of the output shaft;
a control unit for controlling the rotational drive unit, the lifting drive unit and the translational drive unit;
the fixing member including a first and a second end portions extending in a horizontal axis, the first end portion being detachably secured to the output shaft, and the second end portion being detachably secured to the securing portion of the cryo-carrier,
wherein the cryo-carrier securing portion is configured for holding samples to undergo vitrification-cryopreservation.

In one embodiment, the securing portion is secured to a surface of the fixing member, and the securing portion is located outside the surface of the fixing member.

In a further embodiment the securing portion is secured to the surface of the fixing member via at least one detachable clamping member.

In another embodiment, the automated vitrification cryopreservation system further comprises a fixed workbench including a carrier surface having at least one drip area for holding a cryoprotectant, and wherein the drive system controls movements of the cryo-carrier through the fixing member so that the samples on the supporting portion come into contact with the cryoprotectant. In a specific embodiment, the carrier surface is made of a plastic material.

In a further embodiment, the drive system controls movements of the cryo-carrier so that an upper surface of the supporting portion holding the samples comes into contact with the cryoprotectant allowing the samples to be directly immersed in the cryoprotectant or so that a bottom surface of the supporting portion holding the samples comes into contact with the cryoprotectant allowing the samples to be immersed in the cryoprotectant from the bottom surface.

In one embodiment, the carrier surface includes from three to ten independent drip areas continuously arranged along a same line, and in a specific embodiment the carrier surface includes six independent drip areas continuously arranged along the same line.

In another embodiment, the carrier surface further includes at least one suction device for removing excess cryoprotectants. In a specific embodiment, the suction device is a filter paper tip and in a further embodiment, the suction device is independently set apart from the drip areas and is located on or substantially on the same line as the drip areas.

In yet another embodiment, the automated processing system further comprises a cryogenic device, and wherein the drive system moves the cryo-carrier to the cryogenic device so as to immerse the supporting portion holding the samples permeated with the cryoprotectant in a cryogenic agent for freezing. In a specific embodiment, the cryogenic agent is selected from a group consisting of liquid nitrogen and liquid air.

The automated processing system for vitrification-freezing of the present disclosure includes a control mechanism for fixing and controlling the displacement of a cryo-carrier holding samples to be frozen. The control mechanism achieves the operations of immersing the sample on the cryo-carrier in cryoprotectant and removing the cryoprotectant (detaching from the cryoprotectant) by controlling the flipping, lifting, and translation of the cryo-carrier. The system can also transport the cryo-carrier to a cryogenic device and immerse the sample to be frozen in a cryogenic agent to achieve vitrification-freezing. Compared to the existing manual operation methods, the automated processing system can automatically and accurately complete the entire process of vitrification-freezing (cryopreservation) experiments, reducing the instability of manual operations, improving work efficiency, and achieving higher repeatability of results.

### BRIEF DESCRIPTION OF THE FIGURES

Embodiments of the disclosure will be described by way of examples only with reference to the accompanying drawing, in which:

FIG. 1 is a schematic diagram of the automated vitrification cryopreservation system according to an illustrative embodiment of the present disclosure;

FIG. 2 is a schematic structural diagram of an example of a cryo-carrier;

FIG. 3 is a schematic diagram of the drive system of automated vitrification cryopreservation system according to the illustrative embodiment of the present disclosure;

FIG. 4 is a schematic representation of the voice commands recognition system based on visual and audio cues in accordance with the illustrative embodiment of the present disclosure;

FIGS. 5A and 5B are schematic diagram of the structure of a workbench according to a first (FIG. 5A) and second (FIG. 5B) illustrative embodiments of the present disclosure;

FIG. 6 is a flow diagram depicting the automated vitrification-cryopreservation process in accordance with the illustrative embodiment of the present disclosure; and

FIG. 7 is a schematic diagram of the automated vitrification cryopreservation system according to an alternative embodiment of the present disclosure.

Similar references used in different Figures denote similar components.

### DETAILED DESCRIPTION

Generally stated, the non-limitative illustrative embodiments of the present disclosure provide an automated vitrification cryopreservation system, more particularly for the cryopreservation of embryos.

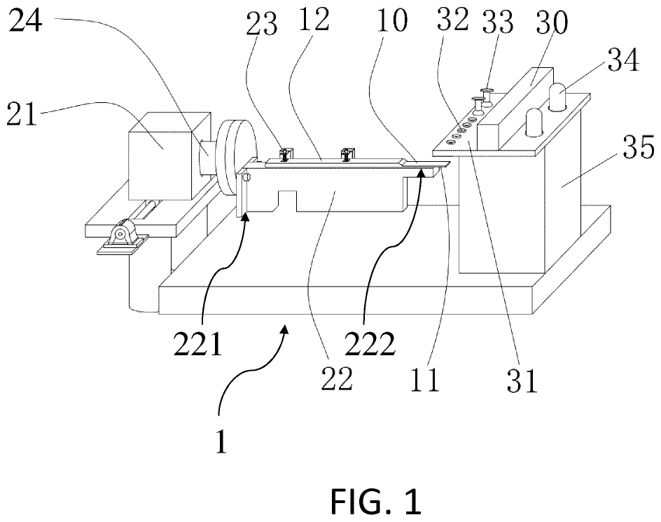

Referring to FIG. 1, there is shown the automated vitrification cryopreservation system 1 according to an illustrative embodiment of the present disclosure, the automated vitrification cryopreservation system 1 includes a cry-carrier 10 and a control mechanism 21, 22 for fixing and controlling the displacement of the cryo-carrier 10.

The cryo-carrier 10 includes a supporting portion 11 for carrying the samples to be cryopreserved and a securing portion 12 fixedly connected to the supporting portion 11.

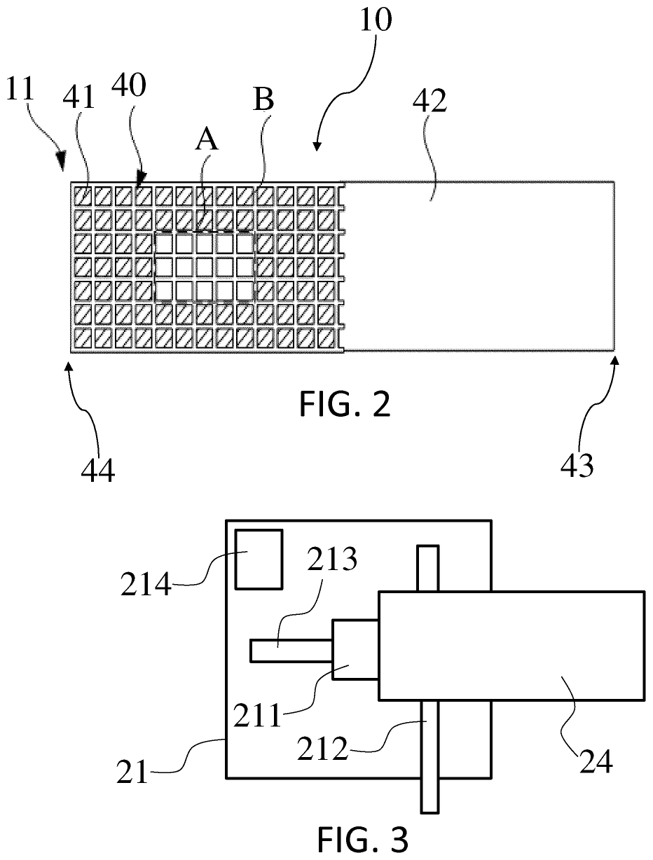

An example of a cryo-carrier 10 that can be used in the automated vitrification cryopreservation system 1 is shown in FIG. 2 and described in more details in PCT patent application PCT/CA2019/000138 filed 3 Oct. 2019 and published as WO2020/093133A1 on 14 May 2020. Specifically, the cryo-carrier 10 includes multiple grids 40 (such as nylon grids) forming the supporting portion 11, which is used to carry the samples to be vitrification-cryopreserved. The supporting portion 11 can also include a sample placement area A (also known as an embryo placement area) and a non-sample placement area B (also known as a non-embryo placement area). The non-sample placement area B surrounds the sample placement area A, and to provide better support for the samples, each of the grids 40 of the non-sample placement area B are filled with support sheets 41 to make the hardness of the non-sample placement area B greater than that of the sample placement area A.

In addition, for easy gripping and control of the cryo-carrier 10, a gripping rod 42 is connected to one end of the supporting portion 11.

In the illustrative embodiment of the automated vitrification cryopreservation system 1, with reference to FIGS. 1 and 2, the supporting portion 11 of the cryo-carrier 10 includes two opposing ends 43, 44, one end being a freely operable end 43, and the other end being a fixed end 44 fixedly connected to the securing portion 12 of the automated vitrification cryopreservation system 1. In the illustrative embodiment, the securing portion 12 is connected to the fixed end 44 of the supporting portion 11 and extends in a direction away from the freely operable end 43. In the illustrative embodiment, the securing portion 12 is integrally formed with the supporting portion 11. However, it is to be understood that in an alternative embodiment the securing portion 12 and the supporting portion 11 may be separate elements joined together.

The control mechanism 21, 22 includes a drive system 21 and a fixing member 22.

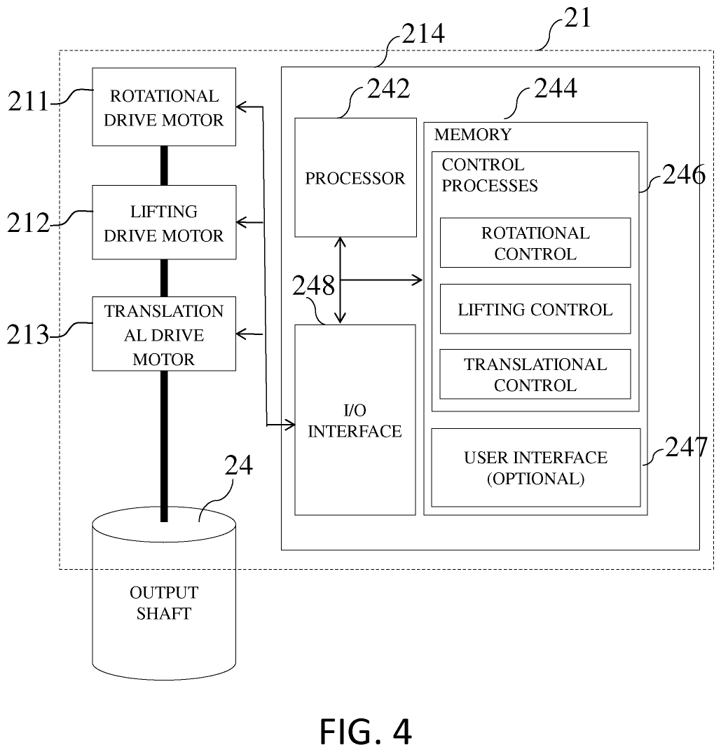

Referring to FIG. 3, the drive system 21, in the illustrative embodiment, includes an output shaft 24 and a rotational drive unit 211 for controlling the rotational movement of the output shaft 24, a lifting drive unit 212 for controlling the vertical movement of the output shaft 24, and a translational drive unit 213 for controlling the horizontal movement of the output shaft 24, all of which are controlled by the control unit 214. The rotational drive unit 211, the lifting drive unit 212, and the translational drive unit 213 can each be implemented using conventional rotational drive motors, lifting drive motors, and translational drive motors known in the art. In an alternative embodiment, one or more of the rotational drive motor 211, lifting drive motor 212, translational drive motor 213, and control unit 214 may be implemented separately from the drive system 21. For example, the control unit 214 may be implemented on a remote device such as a desktop or laptop computer, a tablet or a smart phone.

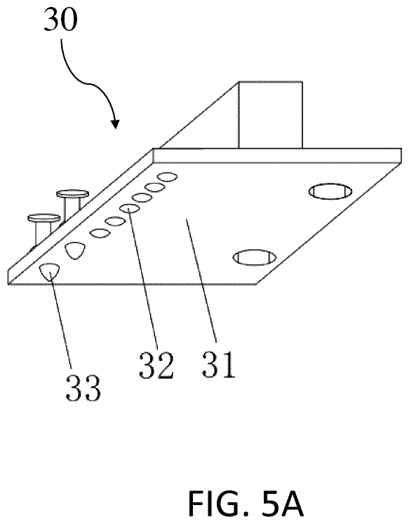

In the illustrative embodiment of the automated vitrification cryopreservation system 1, with further reference to FIG. 4, the control unit 214 of the drive system 21 includes a processor 242 with an associated memory 244 having stored therein processor executable instructions 246 configuring the processor 242 to execute rotational, lifting and translational control processes for controlling the rotational drive motor 211, the lifting drive motor 212, and the translational drive motor 213, to achieve vector control and torque control of the output shaft 24, and consequently the fixing member 22 and the cryogenic carrier 10.

It is to be understood that other processes may be stored in the memory 24 in order to support the control processes 246 or the operation of the automated vitrification cryopreservation system 1, for example an optional user interface process 247.

The control unit 242 further includes an input/output (I/O) interface 248 for communication with rotational drive motor 211, the lifting drive motor 212, and the translational drive motor 213.

The fixing member 22 has two end portions extending in the longitudinal direction, a first portion 221 detachably connected to the output shaft 24, and a second portion 222 detachably connected to the securing portion 12.

In the illustrative embodiment of the automated vitrification cryopreservation system 1, the securing portion 12 is secured to the surface of the fixing member 22 via one or more detachable clamping member 23, and the supporting portion 11 is located outside (extends out of) the fixing member 22.

The drive system 21 controls the flipping, lifting, and translation of the cryo-carrier 10 through the fixing member 22.

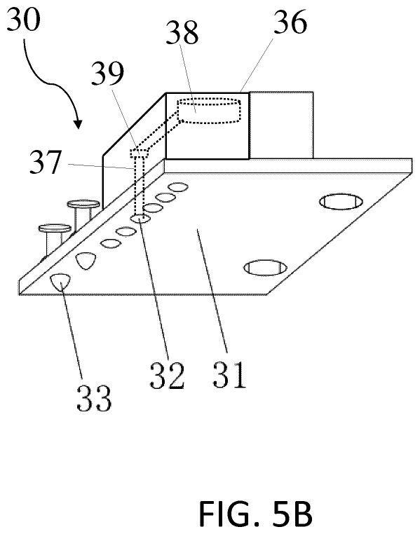

Referring now to FIG. 5A, with further reference to FIG. 1, in a first illustrative embodiment, the automated vitrification cryopreservation system 1 further includes a fixedly arranged workbench 30. The workbench 30 has a carrier surface 31, on which at least one independent droplet area 32 for holding cryoprotectant is provided.

The workbench 30 is horizontally placed, and the carrier surface 31 is downward facing. In an alternative embodiment, the workbench 30 may also be vertically placed. The workbench 30 is fixed to a base 35 through a fixing bolt structure 34. It is to be understood that in an alternative embodiment the workbench 30 may be fixed to the automated vitrification cryopreservation system 1 via other mechanisms, devices, connectors or attachments.

The carrier surface 31 is configured such that a plurality of independent droplet areas 32, for example 3-10, are arranged along a single straight line.

In the illustrative embodiment of the automated vitrification cryopreservation system 1, the carrier surface 31 is provided with six separate droplet areas 32 arranged along a single straight line. The experimental operator pre-drops a certain amount of cryoprotectant, such as cryoprotectants VS or ES, in the droplet areas 32. The placement positions and orders of different cryoprotectants are designed according to the specific experimental procedure.

In an alternative embodiment, the droplet areas 32 may take the form of a cryoprotectant droplet strip or, in a second illustrative embodiment shown in FIG. 5B, the droplet areas 32 may be fed cryoprotectant by a cryoprotectant feeder 36, feeding each droplet area 32 via an associated micropipette or microtube 37 with an inner diameter of, for example, approximately 100 microns, from a cryoprotectant container 38. In another alternative embodiment, the cryoprotectant feeder 36 may control the amount of cryoprotectant introduced into each droplet area 32, for example under the control of the control unit 214 activating an associated valve 39. In a further embodiment, two or more of the above means of providing cryoprotectant may be used in combination.

The carrier surface 31 can be made, for example, of a plastic material, which can retain the cryoprotectant (droplets) on the carrier surface 31 due to surface tension even when facing downward.

In the illustrative embodiment of the automated vitrification cryopreservation system 1, at least one suction member 33, for removing excess cryoprotectant, is fixedly positioned on the carrier surface 31.

The suction member 33 can be, for example, a filter paper head. The upper end of the filter paper head 33 (used for detachable fixing to the workbench) is shown in FIG. 1, and the filter paper head 33 bottom end, protruding downward from the carrier surface 31, is shown in FIG. 5.

The suction member (e.g., filter paper head) 33 is positioned independently from the droplet areas 32 and is located on or substantially on, the same straight line as the droplet areas 32.

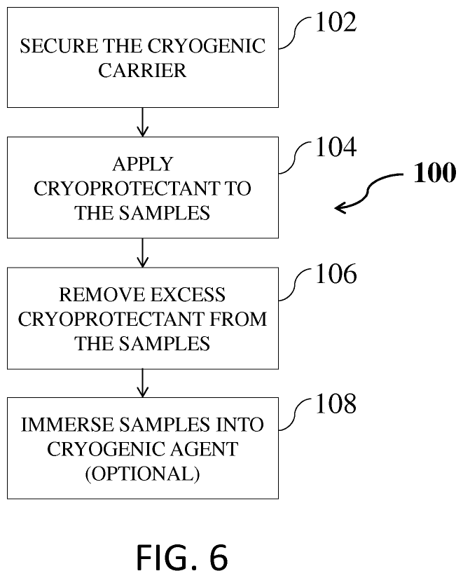

Referring now to FIG. 6, there is shown a flow diagram of the automated vitrification-cryopreservation process 100 of the automated vitrification cryopreservation system 1 in accordance with the illustrative embodiment of the present disclosure. Steps of the process 100 are indicated by blocks 102 to 106.

The process 100 starts at block 102 where the securing portion 12 of the cryogenic carrier 10 is secured to the surface of the fixing member 22 via the one or more detachable clamping member 23, with the supporting portion 11 located/extended outside the fixing member 22.

Then, at block 104, the drive system 21 controls the flipping, lifting, and translation of the cryo-carrier 10 through the fixing member 22, so that the samples on the supporting portion 11 come into contact with the droplets on the droplet areas 32.

Depending on the specific experimental design, the upper surface of the supporting portion 11 (the side surface where the samples are placed) can be brought into contact with the droplet areas 32, allowing the samples to directly contact and be immersed in the cryoprotectant. Alternatively, flipping the cryo-carrier can allow the grids on the bottom surface of the supporting portion 11 (the side surface without samples) to contact the cryoprotectant on the droplet areas 32, enabling the samples to be immersed in the cryoprotectant from the bottom surface.

The drive system 21 controls the movement of the cryo-carrier 10 so that the supporting portion 11 sequentially contacts the cryoprotectant in each droplet area 32.

At block 106, after completing the impregnation process of one type of cryoprotectant, the excess cryoprotectant from the carrier part 11 before immersing it in another type of cryoprotectant. This can be achieved by controlling the movement of the cryo-carrier 10 using the driving system 21, causing it to move away from the droplet area 32 on the carrier part 11 and come into contact with a suction device (filter paper head) 33. Depending on the specific experimental design, the upper surface of the supporting portion 11 (the side where the samples are placed) can be brought into contact with the filter paper head 33 to remove the excess cryoprotectant, or the supporting portion 11 can be flipped so that the grid at the sample location on the bottom side (the side without samples) comes into contact with the filter paper head 33 to remove the excess cryoprotectant from the bottom side.

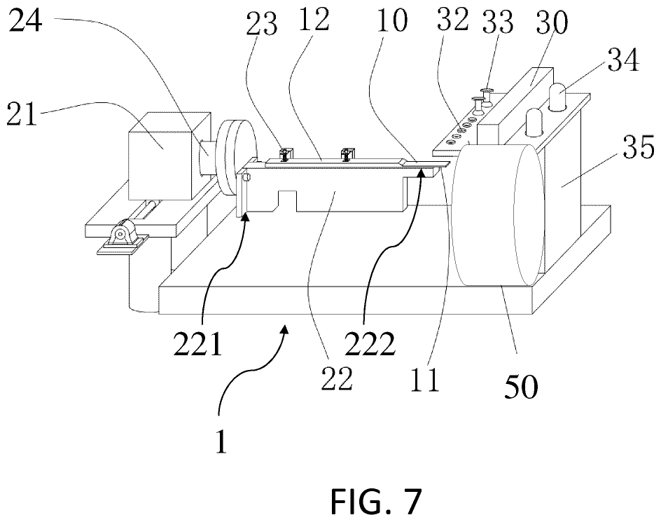

Finally, optionally at block 108 with reference to FIG. 7, after the samples to be frozen undergo sufficient contact (permeation) with the cryoprotectant, the drive system 21 moves the cryo-carrier 10 to a cryogenic device 50 so as to immerse the supporting portion 11 (containing the samples to be frozen) of the cryo-carrier 10 in a ultra-low temperature cryogenic agent, thereby completing the entire operation of vitrification-freezing cryopreservation. Accordingly, in a corresponding alternative embodiment, the automated vitrification cryopreservation system 1 is provided with a cryogenic device 50 for the vitrification-freezing. The cryogenic device 50 can be, for example, a freezing device that contains an ultra-low temperature cryogenic agent such as liquid nitrogen or liquid air.

It is to be understood that the automated vitrification cryopreservation system 1 may also be used to freeze other biological matter, such as, for example, tissues.

Although the present disclosure has been described with a certain degree of particularity and by way of an illustrative embodiment and examples thereof, it is to be understood that the present disclosure is not limited to the features of the embodiments described and illustrated herein, but includes all variations and modifications within the scope of the disclosure as hereinafter claimed.

1. An automated processing system for vitrification-cryopreservation, comprising:
a control mechanism including a fixing member for securing thereto a cryo-carrier having a securing portion and a supporting portion, and a drive system for controlling displacement the fixing member;
the drive system including an output shaft and:
a rotational drive unit for controlling rotational movement of the output shaft;
a lifting drive unit for controlling vertical movement of the output shaft; and
a translational drive unit for controlling horizontal movement of the output shaft;
a control unit for controlling the rotational drive unit, the lifting drive unit and the translational drive unit;
the fixing member including a first and a second end portions extending in a horizontal axis, the first end portion being detachably secured to the output shaft, and the second end portion being detachably secured to the securing portion of the cryo-carrier,
wherein the cryo-carrier securing portion is configured for holding samples to undergo vitrification-cryopreservation.

2. An automated processing system according to claim 1, wherein the securing portion is secured to a surface of the fixing member, and the securing portion is located outside the surface of the fixing member.

3. An automated processing system according to claim 2, wherein the securing portion is secured to the surface of the fixing member via at least one detachable clamping member.

4. An automated processing system according to claim 1, further comprising a fixed workbench including a carrier surface having at least one drip area for holding a cryoprotectant, and wherein the drive system controls movements of the cryo-carrier through the fixing member so that the samples on the supporting portion come into contact with the cryoprotectant.

5. An automated processing system according to claim 1, wherein the drive system controls movements of the cryo-carrier so that an upper surface of the supporting portion holding the samples comes into contact with the cryoprotectant allowing the samples to be directly immersed in the cryoprotectant.

6. An automated processing system according to claim 1, wherein the drive system controls movements of the cryo-carrier so that a bottom surface of the supporting portion holding the samples comes into contact with the cryoprotectant allowing the samples to be immersed in the cryoprotectant from the bottom surface.

7. An automated processing system according to claim 6, wherein the carrier surface includes from three to ten independent drip areas continuously arranged along a same line.

8. An automated processing system according to claim 7, wherein the carrier surface includes six independent drip areas continuously arranged along the same line.

9. An automated processing system according to claim 4, wherein each of the drip areas is fed cryoprotectant by a cryoprotectant feeder via at least one of a micropipette and a microtube.

10. An automated processing system according to claim 9, wherein the micropipette and the microtube have an inner diameter of about 100 microns.

11. An automated processing system according to claim 3, wherein the carrier surface is made of a plastic material.

12. An automated processing system according to claim 3, wherein the carrier surface further includes at least one suction device for removing excess cryoprotectants.

13. An automated processing system according to claim 12, wherein the suction device is a filter paper tip.

14. An automated processing system according to claim 13, wherein the suction device is independently set apart from the drip areas and is located on or substantially on the same line as the drip areas.

15. An automated processing system according to claim 1, further comprising a cryogenic device, and wherein the drive system moves the cryo-carrier to the cryogenic device so as to immerse the supporting portion holding the samples permeated with the cryoprotectant in a cryogenic agent for freezing.

16. An automated processing system according to claim 15, wherein the cryogenic agent is selected from a group consisting of liquid nitrogen and liquid air.
